(19) United States
(12) Patent Application Publication
(10) Pub. No.: US 2010/0254009 A1
(43) Pub. Date: Oct. 7, 2010

(54) ATTACHED FILM

(75) Inventor: CHUN-YUAN CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/755,428

(22) Filed: Apr. 7, 2010

(30) Foreign Application Priority Data
Apr. 7, 2009 (CN) 200910301381.6

(51) Int. Cl. G02B 1/11

(52) U.S. Cl. 359/585; 359/599

(57) ABSTRACT

An attached film for in-mold-decoration is provided to be attached to an outer surface of a molded product. The attached film includes a base layer, an attaching layer, and an anti-reflection layer sandwiched between the attaching layer and the base layer.

### TECHNICAL FIELD

The disclosure relates to an attached film, and particular to an attached film for in-mold-decoration (IMD).

### DESCRIPTION OF RELATED ART

A common method for IMD is covering an attached film to a molded product to decorate or protect the molded product. The attached film usually includes a carrier layer, a peeling layer, and an anti-reflection layer attached to the base of the molded product. While the carrier layer and the peeling layer are released from the molded product, the anti-reflection layer is always damaged to weaken the effect of anti-reflection.

### BRIEF DESCRIPTION OF THE DRAWINGS

FIG. 1 is a cross-sectional view of a first embodiment of an attached film.

FIG. 2 is a cross-sectional view of a second embodiment of the attached film.

FIG. 3 is a cross-sectional view of a third embodiment of the attached film.

FIG. 4 is a cross-sectional view of a fourth embodiment of the attached film.

FIG. 5 is a cross-sectional view of a fifth embodiment of the attached film.

FIG. 6 is a cross-sectional view of a sixth embodiment of the attached film.

FIG. 7 is a cross-sectional view of a seventh embodiment of the attached film.

FIG. 8 is a cross-sectional view of an eighth embodiment of the attached film.

### DETAILED DESCRIPTION

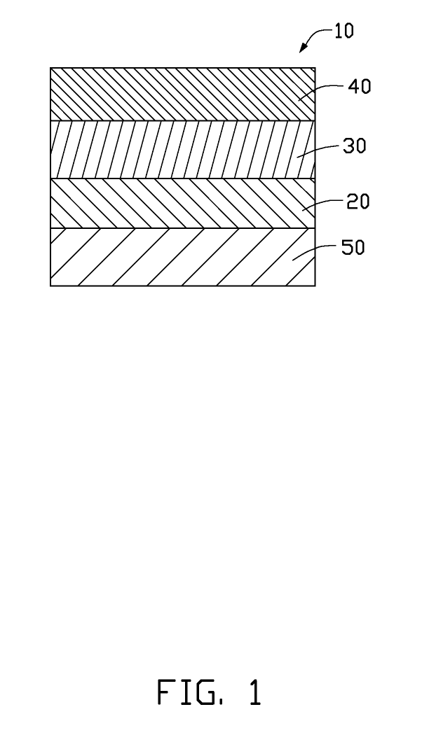

Referring to FIG. 1, a first exemplary embodiment of an attached film 10 for in-mold-decoration includes an attaching layer 20, a base layer 30, and an anti-reflection layer 40.

The attaching layer 20 attaches the attached film 10 to a base 50 of a plastic article made by injecting mold. The attaching layer 20 may be made from one selected from the group consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin, for example. The attaching layer 20 is generally provided via concave, screen, and offset printing, or spraying, dip-coating method, or a coating in reverse order method, for example.

The base layer 30 functions as a scratch/abrasion-resistant layer for the attaching layer 20 and the base 50. The base layer 30 is arranged to the attaching layer 20 opposite to the base 50. The base layer 30 generally consists of at least one of polycarbonate, polyethylene terephthalate, acrylic, oriented polypropylene, or polyvinyl chloride, for example. The thickness of the base layer 30 can range from about 0.01 millimeters to about 0.125 millimeters.

The anti-reflection layer 40 is attached to the base layer 30 opposite to the attaching layer 20. The thickness of the anti-reflection layer 40 is uniform. The surface roughness Ra of the anti-reflection layer 40 can range from about 1.5 nanometers to about 200 nanometers. The anti-reflection effect is achieved by destructive interference of reflected light. Obviously, the surface roughness Ra of the anti-reflection layer 40 can alter according to the need of anti-reflection.

The anti-reflection layer 40 is a vapor deposited layer of a metal compound selected from the group consisting of alumina (Al₂O₃), zinc peroxide (ZnO₂), and magnesium fluoride (MgF₂), a vapor deposited layer in which a metal compound having a low index of refraction selected from the group consisting of Silicon dioxide (SiO₂) and MgF₂, and a metal compound having a high index of refraction selected from the group consisting of ZnO₂ and titanium dioxide (TiO₂) are laminated, or a resin coating layer composed of fluoropolymer, silicon oxide gel. Alternatively, a combination of these materials may be used. Methods of manufacturing the anti-reflection layer 40 may be a vacuum deposition method, a sputtering technique, or ion plating. There also is a method in which the anti-reflection layer 40 is obtained by application of an organic metal compound selected from the group consisting of metal alcoholate and metal chelate onto a transparent substrate by performing a dipping method, a printing process, and a coating process, and subsequent formation of a metal oxide film by performing photo irradiation of drying.

The anti-reflection layer 40 may be composed of only one layer having a low index of refraction, or may be composed of a plurality of anti-reflection layers. Use of the complex layer may improve an anti-reflection property. In ordinary cases, the thickness of the anti-reflection layer 40 may range from 0.01 microns to 2 microns.

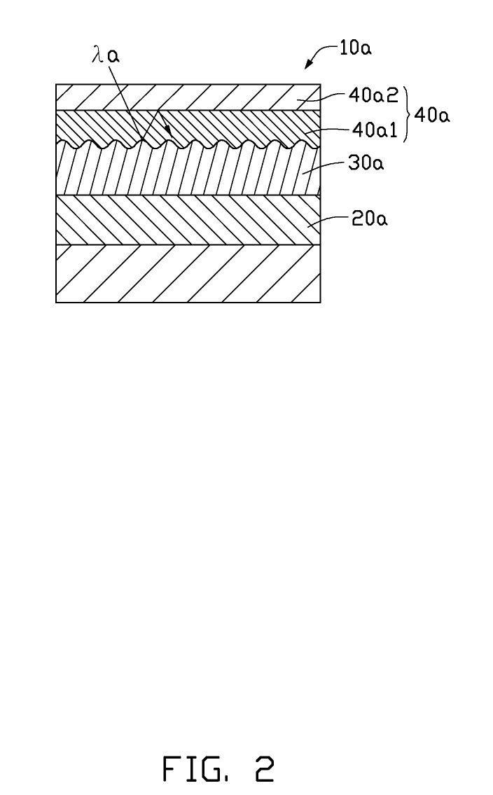

Referring to FIG. 2, a second exemplary embodiment of an attached film 10a includes an attaching layer 20a, a base layer 30ab and an anti-reflection layer 40a. The anti-reflection layer 40a includes an uneven layer 40a1 and a low reflectance layer 40a2. The base layer 30a includes an uneven surface opposite to the uneven layer 40a1.

The uneven layer 40a1 includes an uneven surface facing the uneven surface of the base layer 30a. The uneven layer 40a1 may be made from one of a plurality of resin materials including acrylic resin, polyvinyl chloride resin, cellulosic resin, rubber resin, polyurethane resin, polyvinyl acetate resin, polyester resin, or a copolymer selected from the group consisting of vinyl chloride vinyl acetate copolymer resin and ethylene vinyl acetate copolymer resin. A hardness of the uneven layer 40a1 can be increased with use of thermosetting resin, resin curable by ionizing radiation selected from the group consisting of ultraviolet ray and election beam.

Methods of manufacturing the uneven layer 40a1 include coating selected from the group consisting of gravure coating, roll coating, and comma coating; and a printing process selected from the group consisting of gravure and screen printing.

The low reflectance layer 40a2 is attached to another surface of the uneven layer 40a1 opposite to the base layer 30a. As material of the low reflectance layer 40a2 may use a vapor deposited layer of a metal compound selected from the group consisting of alumina (Al₂O₃), zinc peroxide (ZnO₂), and magnesium fluoride (MgF₂), a vapor deposited layer in which a metal compound having a low index of refraction selected from the group consisting of Silicon dioxide (SiO₂) and MgF₂ and a metal compound having a high index of refraction selected from the group consisting of ZnO₂ and TiO₂ are laminated, or a resin coating layer composed of fluoropolymer, and silicon oxide gel. Alternatively, a combination of these materials may be used. Methods of manufacturing the anti-reflection layer 40 may be a vacuum deposition method, a sputtering technique, or ion plating. There is also a method in which the anti-reflection layer 40 is obtained by application of an organic metal compound selected from the group consisting of metal alcoholate and metal chelate onto a transparent substrate by performing a dipping method, a printing process, and a coating process, and subsequent formation of a metal oxide film by performing photo irradiation of drying.

The anti-reflection layer 40a not only may improve an anti-reflection property, but also may improve transmittance. An incident light λa may be reflected by the uneven surface of the uneven layer 40a1. The light reflected by the uneven surface of the uneven layer 40a1 is reflected again by an interface of the uneven layer 40a1 and the low reflectance layer 40a2. Therefore, the incident light λa is difficult to emit from an outer surface of the attached film 10a.

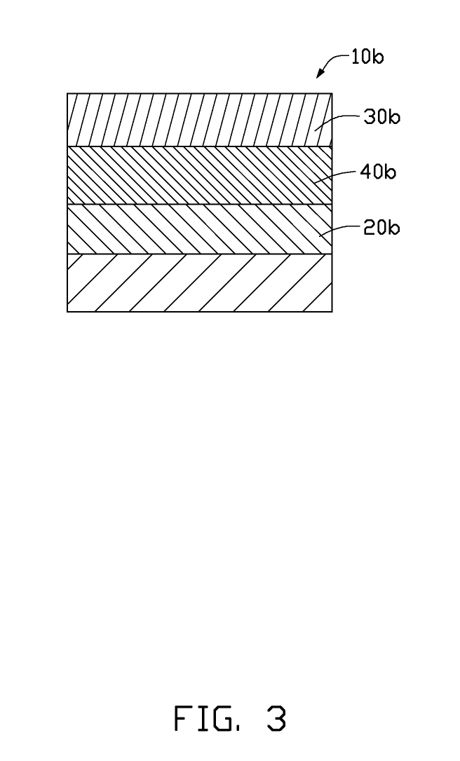

Referring to FIG. 3, a third exemplary embodiment of an attached film 10b includes an attaching layer 20b, a base layer 30b, and an anti-reflection layer 40b sandwiched between the attaching layer 20b and the base layer 30b. The thickness of the anti-reflection layer 40b is uniform. The anti-reflection effect is achieved by destructive interference of reflected light.

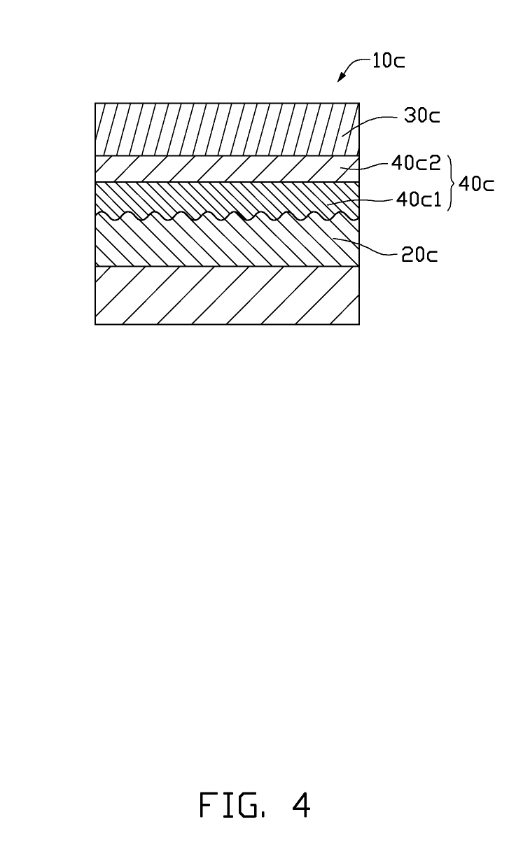

Referring to FIG. 4, a fourth exemplary embodiment of an attached film 10c includes an attaching layer 20c, a base layer 30c, and an anti-reflection layer 40c sandwiched between the attaching layer 20c and the base layer 30c. The anti-reflection layer 40c includes an uneven layer 40c1 and a low reflectance layer 40c2. The attaching layer 20c includes an uneven surface facing the uneven layer 40c1. The uneven layer 40a1 includes an uneven surface facing the uneven surface of the attaching layer 20c. An incident light reflected by the uneven surface of the uneven layer 40c1 is reflected again by an interface of the uneven layer 40c1 and the low reflectance layer 40c2. Therefore, the incident light is difficult to emit from an outer surface of the attached film 10c.

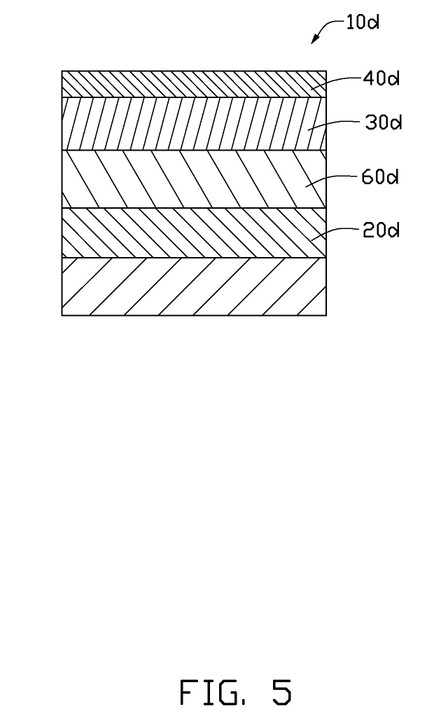

Referring to FIG. 5, a fifth exemplary embodiment of an attached film 10d for in-mold-decoration includes an attaching layer 20d, a base layer 30d, an anti-reflection layer 40d attached to the base layer 30d opposite to the attaching layer 20d, and a pattern layer 60d sandwiched between the attaching layer 20d and the base layer 30d.

The pattern layer 60d may be provided by printing ink on the base layer 30d. A metal decorative layer can be provided as the pattern layer 60d. The metal decorative layer may be aluminum, chromium, copper, nickel, indium, or tin, alone or combined, on the base layer 30d via either a vacuum evaporation or electroplating method.

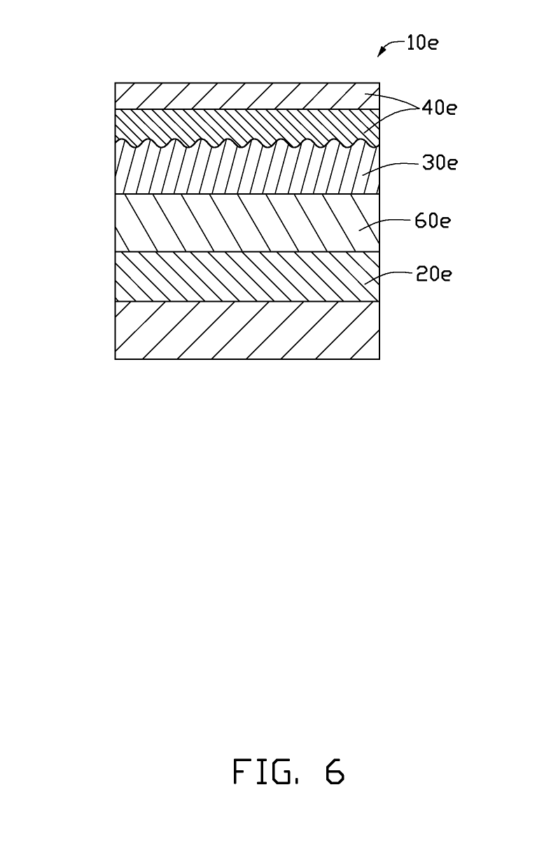

Referring to FIG. 6, a sixth exemplary embodiment of an attached film 10e includes an attaching layer 20e, a base layer 30e, an anti-reflection layer 40e attached to the base layer 30e opposite to the attaching layer 20e, and a pattern layer 60e sandwiched between the attaching layer 20e and the base layer 30e. The base layer 30e includes an uneven surface facing the anti-reflection layer 40e. The anti-reflection layer 40e includes an uneven surface facing the uneven surface of the base layer 30e.

The pattern layer 60e may be provided by printing ink on the base layer 30e. A metal decorative layer can be provided as the pattern layer 60e. The metal decorative layer plating may be aluminum, chromium, copper, nickel, indium, or tin, alone or combined, on the base layer 30e via either a vacuum evaporation or electroplating method.

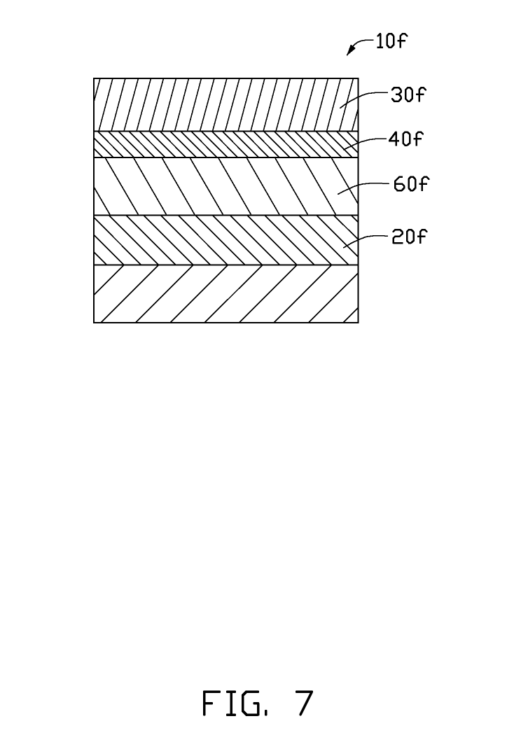

Referring to FIG. 7, a seventh exemplary embodiment of an attached film 10f for in-mold-decoration includes an attaching layer 20f, a base layer 30f, an anti-reflection layer 40f, and a pattern layer 60f sandwiched between the attaching layer 20f and the anti-reflection layer 40f. The anti-reflection layer 40f is sandwiched between the base layer 30f and the pattern layer 60f. The thickness of the anti-reflection layer 40f is uniform. The anti-reflection effect is achieved by destructive interference of reflected light.

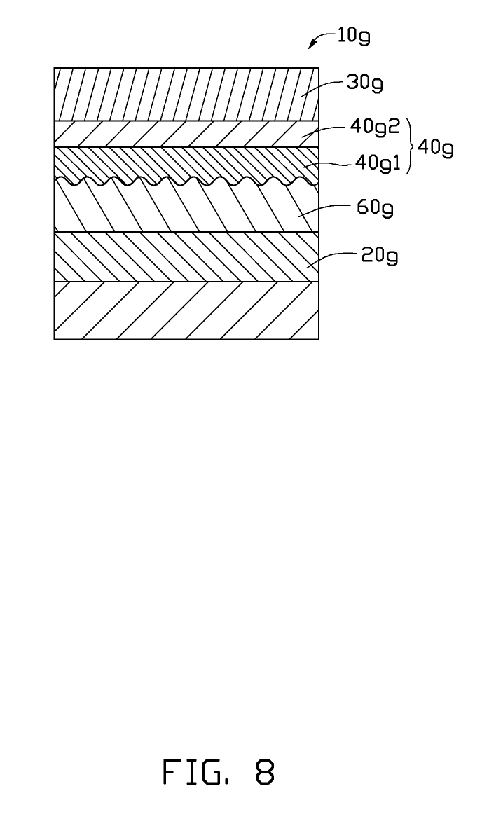

Referring to FIG. 8, an eighth exemplary embodiment of an attached film 10g includes an attaching layer 20g, a base layer 30g, an anti-reflection layer 40g and a pattern layer 60g sandwiched between the attaching layer 20g and the anti-reflection layer 40g. The anti-reflection layer 40g is sandwiched between the base layer 30g and the pattern layer 60g. The anti-reflection layer 40g includes an uneven layer 40g1 and a low reflectance layer 40g2. The pattern layer 60g includes an uneven surface facing the uneven layer 40g1. The uneven layer 40g1 includes an uneven surface facing to the uneven surface of the pattern layer 60g. An incident light reflected by the uneven surface of the uneven layer 40g1 is reflected again by an interface of the uneven layer 40g1 and the low reflectance layer 40g2. Therefore, the incident light is difficult to emit from an outer surface of the attached film 10g.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. An attached film for in-mold-decoration, the attached film comprising:
a base layer;
an attaching layer attached to a first side of the base layer; and
an anti-reflection layer attached to a second side of the base layer opposite to the attaching layer, wherein the surface roughness of the anti-reflection layer ranges from about 1.5 nanometers to about 200 nanometers.

2. The attached film of claim 1, wherein the attaching layer is made from a resin material selected from the group consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin.

3. The attached film of claim 1, wherein the base layer generally comprises at least one of polycarbonate, polyethylene terephthalate, acrylic, oriented polypropylene, or polyvinyl chloride.

4. The attached film of claim 1, wherein the anti-reflection layer is made from a material selected from the group consisting of:
a vapor deposited layer of a metal compound selected from the group consisting of alumina (Al₂O₃), zinc peroxide (ZnO₂), and magnesium fluoride (MgF₂);
a vapor deposited layer in which a metal compound having a low index of refraction selected from the group consisting of Silicon dioxide (SiO₂) and MgF₂ and a metal compound having a high index of refraction selected from the group consisting of ZnO₂ and titanium dioxide (TiO₂) are laminated; and
a resin coating layer composed of fluoropolymer, silicon oxide gel.

5. The attached film of claim 1, wherein the attached film further comprises a pattern layer sandwiched between the attaching layer and the base layer, the pattern layer is provided by printing ink on the base layer.

6. The attached film of claim 1, wherein the attached film further comprises a pattern layer sandwiched between the attaching layer and the base layer, a metal decorative layer is provided as the pattern layer, the metal decorative layer is aluminum, chromium, copper, nickel, indium, or tin, alone or combined, on the base layer.

7. An attached film for in-mold-decoration, the attached film comprising:
a base layer;
an attaching layer attached to a first side of the base layer; and
an anti-reflection layer comprising an uneven layer attached to a second side of the base layer opposite to the attaching layer, and a low reflectance layer attached to the uneven layer opposite to the base layer.

8. The attached film of claim 7, wherein the attached film further comprises a pattern layer sandwiched between the attaching layer and the base layer.

9. The attached film of claim 7, wherein the base layer comprises a first uneven surface facing the uneven layer, the uneven layer comprises a second uneven surface facing the first uneven surface of the base layer.

10. The attached film of claim 7, wherein the uneven layer is made either from a resin material selected from the group consisting of acrylic resin, polyvinyl chloride resin, cellulosic resin, rubber resin, polyurethane resin, polyvinyl acetate resin, and polyester resin, or from a copolymer selected from the group consisting of vinyl chloride vinyl acetate copolymer resin and ethylene vinyl acetate copolymer resin.

11. The attached film of claim 7, wherein the low reflectance layer is a vapor deposited layer of a metal compound selected from the group consisting of alumina (Al₂O₃), zinc peroxide (ZnO₂), and magnesium fluoride (MgF₂), a vapor deposited layer in which a metal compound having a low index of refraction selected from the group consisting of Silicon dioxide (SiO₂) and MgF₂, and a metal compound having a high index of refraction selected from the group consisting of ZnO₂ and titanium dioxide (TiO₂) are laminated, or a resin coating layer composed of fluoropolymer, silicon oxide gel.

12. An attached film for in-mold-decoration, the attached film comprising:
a base layer;
an attaching layer; and
an anti-reflection layer sandwiched between the attaching layer and the base layer.

13. The attached film of claim 12, wherein the anti-reflection layer comprises an uneven layer attached to the attaching layer, and a low reflectance layer between the base layer and the uneven layer.

14. The attached film of claim 13, wherein the attaching layer comprises a first uneven surface facing the uneven layer, the uneven layer comprises a second uneven surface facing the first uneven surface of the attaching layer.

15. The attached film of claim 13, wherein the attached film further comprises a pattern layer sandwiched between the attaching layer and the uneven layer.

16. The attached film of claim 15, wherein the pattern layer comprises a first uneven surface facing the uneven layer, the uneven layer comprises a second uneven surface facing the first uneven surface of the pattern layer.

17. The attached film of claim 13, wherein the uneven layer is made either from a resin material selected from the groups consisting of acrylic resin, polyvinyl chloride resin, cellulosic resin, rubber resin, polyurethane resin, polyvinyl acetate resin, and polyester resin, or from a copolymer selected from the group consisting of vinyl chloride vinyl acetate copolymer resin and ethylene vinyl acetate copolymer resin.

18. The attached film of claim 13, wherein the low reflectance layer is a vapor deposited layer of a metal compound selected from the group consisting of alumina (Al₂O₃), zinc peroxide (ZnO₂), and magnesium fluoride (MgF₂), a vapor deposited layer in which a metal compound having a low index of refraction selected from the group consisting of Silicon dioxide (SiO₂) and MgF₂, and a metal compound having a high index of refraction selected from the group consisting of ZnO₂ and titanium dioxide (TiO₂) are laminated, or a resin coating layer composed of fluoropolymer, silicon oxide gel.

19. The attached film of claim 12, wherein the anti-reflection layer is a vapor deposited layer of a metal compound selected from the group consisting of alumina (Al₂O₃), zinc peroxide (ZnO₂), or magnesium fluoride (MgF₂), a vapor deposited layer in which a metal compound having a low index of refraction selected from the group consisting of Silicon dioxide (SiO₂) and MgF₂, and a metal compound having a high index of refraction selected from the group consisting of ZnO₂ and titanium dioxide (TiO₂) are laminated, or a resin coating layer composed of fluoropolymer, silicon oxide gel.

20. The attached film of claim 12, wherein the attaching layer is made from a resin material selected from the group consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin.
